(19) United States
(12) Patent Application Publication
(10) Pub. No.: US 2025/0175965 A1
(43) Pub. Date: May 29, 2025

(54) DYNAMIC ALTERATION OF BEAM INFORMATION

(71) Applicant: QUALCOMM Incorporated, San Diego, CA (US)

(72) Inventors: Qiaoyu Li, Beijing (CN); Hamed Pezeshki, San Diego, CA (US); Mahmoud Taherzadeh Boroujeni, San Diego, CA (US); Tao Luo, San Diego, CA (US)

(21) Appl. No.: 18/839,859

(22) PCT Filed: Apr. 29, 2022
(86) PCT No.: PCT/CN2022/090638

§ 371 Date: Aug. 20, 2024

(51) Int. Cl. H04W 72/044; H04W 16/28; H04W 72/23; H04W 72/542

(52) U.S. Cl. CPC H04W 72/046; H04W 16/28; H04W 72/23; H04W 72/542

(57) ABSTRACT

This disclosure provides systems, methods, and devices for wireless communication that support dynamic beam adjustment. In a first aspect, a method of wireless communication includes at least one processor and a memory coupled to the at least one processor. The at least one processor is configured to obtain first beam information. The first beam information includes at least one of first beam shape information or first inter-beam pointing direction neighboring information. The at least one processor is configured to receive a transmission including an indication indicative of a change to beam information, and switch from the first beam information to second beam information based on the indication. The at least one processor is configured to perform one or more operations based on the second beam information. Other aspects and features are also claimed and described.

### TECHNICAL FIELD

Aspects of the present disclosure relate generally to wireless communication systems, and more particularly, to dynamic alteration of beam information. Some features may enable and provide improved communications, including dynamic alteration of beam shape and/or neighboring information.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes obtaining first beam information. The first beam information includes at least one of: first beam shape information or first inter-beam pointing direction neighboring information. The method includes receiving a transmission including an indication indicative of a change to beam information, and switching from the first beam information to second beam information based on the indication. The method includes performing one or more operations based on the second beam information.

In an additional aspect of the disclosure, an apparatus includes at least one processor and a memory coupled to the at least one processor. The at least one processor is configured to obtain first beam information. The first beam information includes at least one of: first beam shape information or first inter-beam pointing direction neighboring information. The at least one processor is configured to receive a transmission including an indication indicative of a change to beam information, and switch from the first beam information to second beam information based on the indication. The at least one processor is configured to perform one or more operations based on the second beam information.

In an additional aspect of the disclosure, an apparatus includes means for obtaining first beam information. The first beam information includes at least one of: first beam shape information or first inter-beam pointing direction neighboring information. The apparatus includes means for receiving a transmission including an indication indicative of a change to beam information, and means for switching from the first beam information to second beam information based on the indication. The apparatus includes means for performing one or more operations based on the second beam information.

In an additional aspect of the disclosure, a non-transitory computer-readable medium stores instructions that, when executed by a processor, cause the processor to perform operations. The operations include obtaining first beam information. The first beam information includes at least one of: first beam shape information or first inter-beam pointing direction neighboring information. The operations include receiving a transmission including an indication indicative of a change to beam information, and switching from the first beam information to second beam information based on the indication. The operations include performing one or more operations based on the second beam information.

In another aspect of the disclosure, a method for wireless communication includes obtaining transmitting beam information. The first beam information includes at least one of: first beam shape information or first inter-beam pointing direction neighboring information. The method includes transmitting a transmission including an indication indicative of a change to beam information, and switching from the first beam information to second beam information based on the indication. The method includes performing one or more operations based on the second beam information.

In an additional aspect of the disclosure, an apparatus includes at least one processor and a memory coupled to the at least one processor. The at least one processor is configured to transmit first beam information. The first beam information includes at least one of: first beam shape information or first inter-beam pointing direction neighboring information. The at least one processor is configured to transmit a transmission including an indication indicative of a change to beam information, and switch from the first beam information to second beam information based on the indication. The at least one processor is configured to perform one or more operations based on the second beam information.

In an additional aspect of the disclosure, an apparatus includes means for transmitting first beam information. The first beam information includes at least one of: first beam shape information or first inter-beam pointing direction neighboring information. The apparatus includes means for transmitting a transmission including an indication indicative of a change to beam information, and means for switching from the first beam information to second beam information based on the indication. The apparatus includes means for performing one or more operations based on the second beam information.

In an additional aspect of the disclosure, a non-transitory computer-readable medium stores instructions that, when executed by a processor, cause the processor to perform operations. The operations include transmitting first beam information. The first beam information includes at least one of: first beam shape information or first inter-beam pointing direction neighboring information. The operations include transmitting a transmission including an indication indicative of a change to beam information, and switching from the first beam information to second beam information based on the indication. The operations include performing one or more operations based on the second beam information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example of semi-static or static configuration of beam information according to one or more aspects.

FIG. 4 is a block diagram illustrating an example wireless communication system that supports dynamic alteration of beam information according to one or more aspects.

FIG. 5 is a timing diagram illustrating a wireless communication system that supports dynamic alteration of beam information according to one or more aspects.

FIG. 6 is a timing diagram illustrating a wireless communication system that supports dynamic alteration of beam information according to one or more aspects.

FIG. 7 is a timing diagram illustrating a wireless communication system that supports dynamic alteration of beam information according to one or more aspects.

FIG. 8 is a block diagram illustrating various durations for dynamic alteration of beam information according to one or more aspects.

FIG. 9 is a block diagram illustrating various signaling options for dynamic alteration of beam information according to one or more aspects.

FIGS. 10A and 10B are a block diagrams illustrating example MAC-CE formats for dynamic alteration of beam information according to one or more aspects.

FIG. 11 is a flow diagram illustrating an example process that supports dynamic alteration of beam information according to one or more aspects.

FIG. 12 is a flow diagram illustrating another example process that supports dynamic alteration of beam information according to one or more aspects.

FIG. 13 is a block diagram of an example UE that supports dynamic alteration of beam information according to one or more aspects.

FIG. 14 is a block diagram of an example base station that supports dynamic alteration of beam information according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

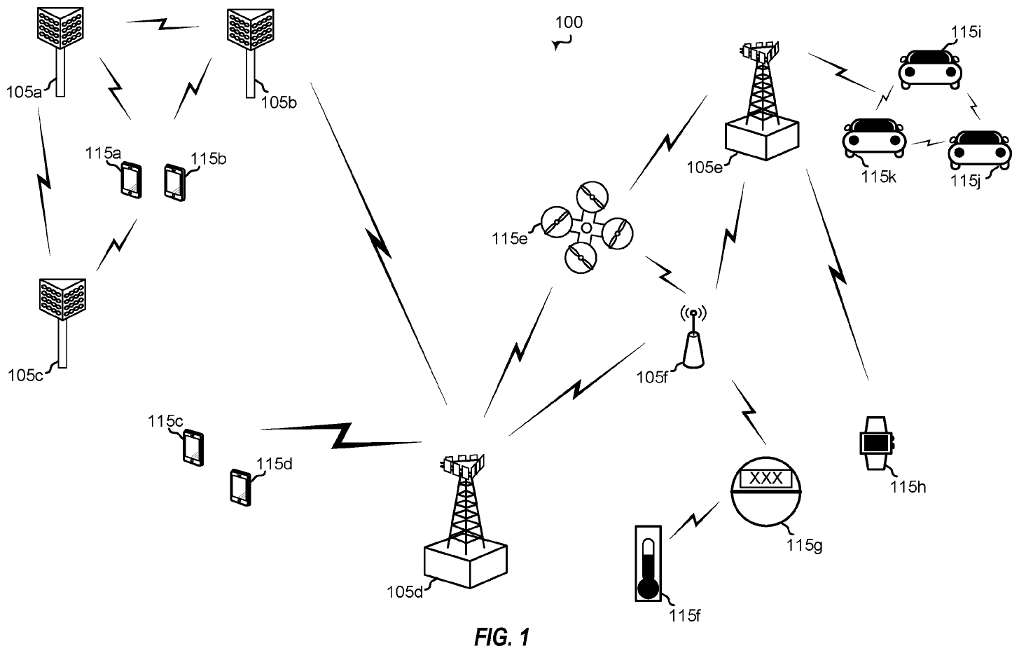

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

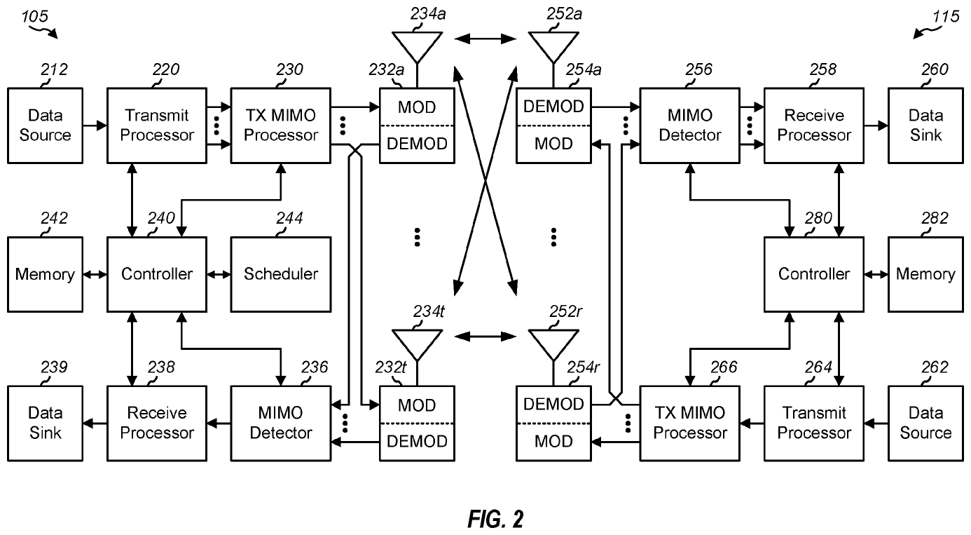

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 1-14, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

During operation of a wireless communication network, a network entity, such as a base station, may adjust beam pointing directions or angular-specific beam shapes, such as for reference signals like CSI-RS, to adjust for or match with channel related changes. As an illustrative example, UE movement may result inter-cell or inter-UE interference. As another example, the UE or network may experience environmental changes, such as transient or static changes.

Current schemes focus on RRC configurations for beam adjustment. However, using RRC configuration may incur excessively long latency to reconfigure the beam neighboring or beam shape information and may not sufficiently adapt to such dynamically varied beam pointing directions triggered by the base station.

In the aspects described herein, methods and systems for dynamic adjustment of beam information, including beam shape and/or neighboring information are described. For example, MAC-CE and DCI transmissions may be used to more quickly, as compared to RRC, effectuate a beam change and can support dynamically varied beam pointing directions triggered by the base station. Additionally, using such MAC-CE and DCI transmissions, along with the implementations described herein, may reduce overhead and signaling impact to accommodate dynamic beam adjustment.

In some aspects where DCI is used to provide a dynamic beam adjustment indication, a missed DCI may cause beam mismatch. In some implementations, a beam mismatch between UE and network (e.g., a difference in what beam the network expects versus what the UE is using or vice versa) could be severe enough to cause beam or radio link failure. In the aspects described herein, signaling implementations are described to reduce beam mismatch by controlling or indicating a duration of the dynamic beam adjustment.

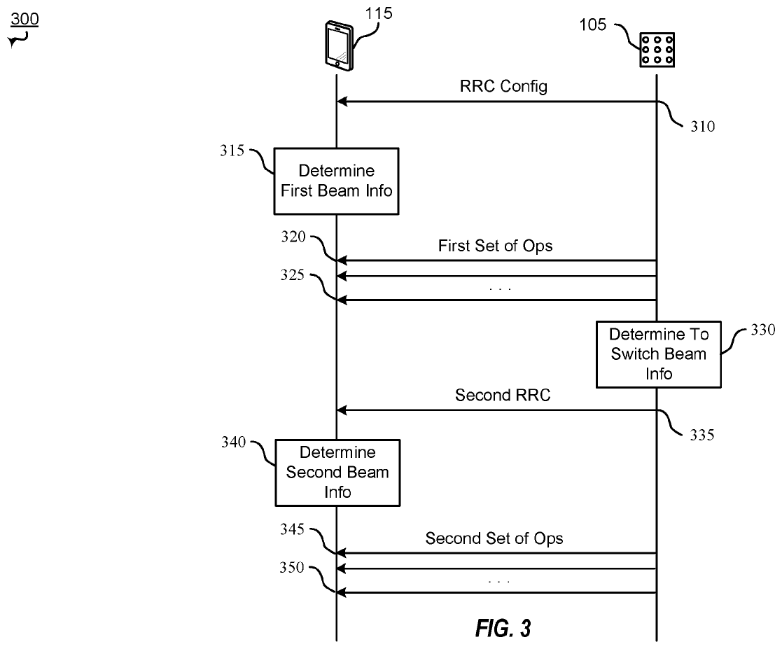

FIG. 3 is a block diagram illustrating an example of semi-static or static configuration of beam information according to one or more aspects. In the example of FIG. 3, a diagram 300 of a network using RRC configuration for beam adjustment is depicted. The network may include a base station 105 and a UE 115.

At 310, the base station 105 transmits a first RRC configuration including beam shape information and/or beam neighbor information (also referred to as beam neighboring information).

At 315, the UE 115 receives the RRC configuration and determines information for a first beam, first beam information, based on the beam shape information and/or beam neighbor information.

From 320 to 325, the UE 115 performs a first set of operations with the first beam. The operations may include transmitting or receiving communications based on the first beam, such as by using first beam information to transmit via the first beam.

While performing the first set of operations, the UE 115 may experience a decrease in signal quality. The decrease in signal quality may be caused by a change at the UE (e.g., movement or rotation) or a change in the channel (e.g., blockage or interference). This decrease in signal quality could lead to beam failure or even radio link failure. As a determination or permission to use a new beam may be determined by the network and signaled through a RRC message, the network may not be able to dynamically adjust beam shape information and/or beam neighbor information during the first set of operations or for/during resources configured by the first RRC configuration.

At 330, the base station 105 may determine to or grant permission to use another beam, such as based on UE 115 feedback or a network determination. For example, the UE 115 may request a new beam after beam failure or provide indications of decreasing quality through channel reporting, such as in a CSI report.

At 335, the base station 105 transmits a second RRC configuration including modified beam shape information and/or beam neighbor information.

At 340, the UE 115 receives the second RRC configuration and determines information for a second beam, second beam information, based on the modified beam shape information and/or beam neighbor information.

From 345 to 350, the UE 115 performs a second set of operations with the second beam. The operations may include transmitting or receiving communications based on the second beam, such as by using second beam information.

Accordingly, in the example of FIG. 3 the network is not able to dynamically adjust beam information and instead utilizes RRC to adjust beam information for a set of resources and/or set of processes.

In the aspects described herein, a network may dynamically adjust beam information, such as beam shape information and/or beam neighbor information to provide enhanced beam flexibility and enable faster adaptation to channel conditions. Such dynamic beam adjustment may be enabled by utilizing MAC-CE and/or DCI transmissions to indicate a change in beam information and may reduce failed transmissions. Thus, the aspects described herein may reduce latency and increase throughput, which results in a more efficient network.

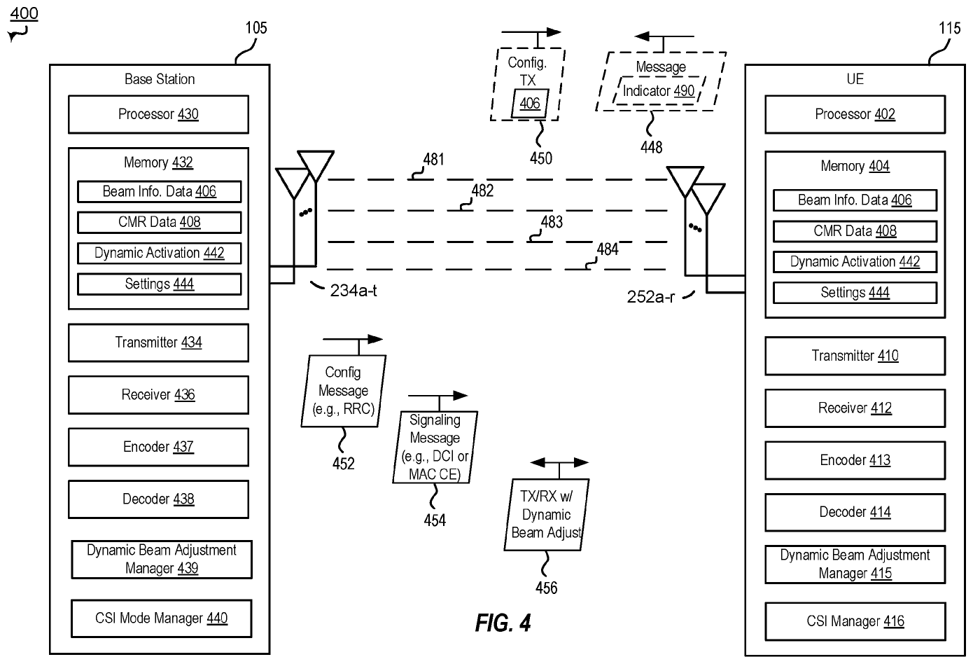

FIG. 4 illustrates an example of a wireless communications system 400 that supports dynamic alteration of beam information in accordance with aspects of the present disclosure. In some examples, wireless communications system 400 may implement aspects of wireless communication system 100. For example, wireless communications system 400 may include a network, such as one or more network entities, and one or more UEs, such as UE 115. As illustrated in the example of FIG. 4, the network entity includes a corresponds to a base station, such as base station 105. Alternatively, the network entity may include or correspond to a different network device (e.g., not a base station). Dynamic alteration of beam information operations may reduce beam or radio link failure, and thus reduce latency and increase throughput. Accordingly, network and device performance can be increased.

Base station 105 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via base station 105 and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, dynamic beam adjustment manager 415, CSI manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store beam information data 406, channel measurement resource data 408, dynamic activation data 442, settings data 444, or a combination thereof, as further described herein.

The beam information data 406 includes or corresponds to data associated with or corresponding to beam information for dynamically adjusted beams. For example, the beam information data 406 may include beam shape information, beam neighbor information, or a combination thereof. The beam shape information may include beam pointing direction or angle, beam width, beam weights or coefficients, reference signal information, or a combination thereof. The beam neighbor information may include spatial information regarding one or more beams, such as adjacent beam information, beam (e.g., reference signal) mapping information, etc. In some implementations, the beam neighbor information includes inter-beam pointing direction neighboring information. The inter-beam pointing direction neighboring information may include spatial information indicates one or more adjacent beams for a particular beam (e.g., the first beam, the second beam, etc.). The spatial information may include or be indicated by mapping information, and may include associations between reference signals. The beam information data 406 may be configured by RRC and/or modified by MAC-CE and/or DCI.

The channel measurement resource data 408 includes or corresponds to data associated with or corresponding to resources used for channel measurements and quality determinations, such as for CSI reporting. For example, the channel measurement resource data 408 may include channel measurement resource (CMR) set information, CMR resource information, or a combination thereof. The CMR set information may include CMR resource or set identifiers, and the CMR set information or CMR resource information may be associated or linked with beam information (e.g., beam information data 406) for dynamic beam adjustment.

In some implementations, the channel measurement resource data 408 may include or be associated with data for channel quality measurements, channel characteristics, layer information, precoding information, or a combination thereof. To illustrate, the channel measurement resource data 408 include physical layer power and/or quality measurements and/or metrics. The channel measurement resource data 408 may be use to generate CSI report data.

The CSI report data includes or corresponds to data indicating or corresponding to CSR report transmissions. For example, the CSI report data may include data indicating information of the CSI report transmissions, e.g., the payload or traffic. As an example, the CSI report data includes precoding information, rank indicator information, channel quality information, or a combination thereof.

The dynamic activation data 442 includes or corresponds to data indicating or corresponding to an activation (or triggering) of a CSI report, a dynamic beam adjustment, or both. For example, the dynamic activation data 442 may include data indicating information of the CSI report transmissions, such as CSI request information. As an example, the CSI request information includes an indication of one or more CSI request activation or triggering states. The CSI triggering or activation states may be associated with beam information directly, or through an intermediary, such as via CMR set information.

The settings data 444 includes or corresponds to data associated with dynamic beam adjustment operations. The settings data 444 may include one or more types of dynamic beam adjustment operation modes and/or thresholds or conditions for switching between dynamic beam adjustment modes and/or configurations. For example, the settings data 444 may have data indicating different thresholds and/or conditions for different dynamic beam adjustment modes, such as a single signaling mode, a multiple signaling mode, an implicit operation mode, an explicit configuration mode (e.g., including of beam information in DCI or MAC-CE), etc., or a combination thereof.

Additionally, or alternatively, the settings data 444 may include one CSI report settings information. For example, the settings data 444 may include CSI-RS resource information, CSI-RS report configuration information, CSI-RS report timing information, CSI-RS report timing triggering mode/type, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Dynamic beam adjustment manager 415 (e.g., an enhanced dynamic beam adjustment manager) may be configured to determine and perform enhanced dynamic beam adjustment operations. For example, dynamic beam adjustment manager 415 may be configured to determine an indication of a dynamic beam adjustment. To illustrate, the UE may parse DCI and/or MAC-CE message for an indication of second beam or for the second beam information itself. For an indication, the dynamic beam adjustment manager 415 may determine an association of the indication and link the association to beam information. To illustrate, channel management resources may be linked with CSI state information of the DCI or MAC-CE, and beam information associated with the channel management resources may be used as modified beam information. As another example, dynamic beam adjustment manager 415 is configured to determine a duration of the dynamic adjustment and when or whether to cancel or deactivate the dynamic beam adjustment.

CSI manager 416 may be configured to determine CSI measurement and reporting operations, such as CSI measurement and reporting operations for enhanced dynamic beam adjustment operations. For example, CSI manager 416 is configured to determine when to measure, what to measure, when to report, what to report, who to report to, etc. Additionally, CSI manager 416 may be configured to determine CMR information associated with CSI state information and with dynamic beam information.

Base station 105 includes processor 430, memory 432, transmitter 434, receiver 436, encoder 437, decoder 438, dynamic beam adjustment manager 439, CSI manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store beam information data 406, channel measurement resource data 408, dynamic activation data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of UE 115 described with reference to FIG. 2.

Encoder 437, and decoder 438 may include the same functionality as described with reference to encoder 413 and decoder 414, respectively. Dynamic beam adjustment manager 439 may include similar functionality as described with reference to dynamic beam adjustment manager 415. CSI manager 440 may include similar functionality as described with reference to CSI manager 416.

During operation of wireless communications system 400, the network (e.g., base station 105) may determine that UE 115 has dynamic alteration of beam information operation capability. For example, UE 115 may transmit a message 448 that includes a dynamic alteration of beam information indicator 490 (e.g., a dynamic alteration of beam information capability indicator). Indicator 490 may indicate dynamic alteration of beam information operation capability for one or more communication modes, such as downlink, uplink, etc. In some implementations, a network entity (e.g., a base station 105) sends control information to indicate to UE 115 that dynamic alteration of beam information operation and/or a particular type of dynamic alteration of beam information operation is to be used. For example, in some implementations, message 448 (or another message, such as configuration transmission 450) is transmitted by the UE 115. The configuration transmission 450 may include or indicate to use dynamic alteration of beam information operations or to adjust or implement a setting of a particular type of dynamic alteration of beam information operation. For example, the configuration transmission 450 may include beam information data 406, as indicated in the example of FIG. 4, channel measurement resource data 408, settings data 444 or any combination thereof.

During operation, devices of wireless communications system 400, perform dynamic alteration of beam information operations. For example, the network and UE 115 may exchange transmissions via uplink and/or downlink communications, such as via a downlink channel as illustrated in the example of FIG. 4.

In the example of FIG. 4, the base station 105 transmits a configuration message 452 for dynamic alteration of beam information. The configuration message 452 may include or correspond to configuration message for channel management resources. For example, the configuration message 452 may include or correspond to an RRC configuration message which indicates or includes channel measurement resource data 408. In some other implementations, the configuration message 452 comprises a MAC-CE or DCI transmission. Examples of configuration indications and messages are illustrated and described further with reference to FIGS. 5-7.

The UE 115 may receive the configuration message 452 and may perform one or more evaluations or determinations on the configuration message 452. The UE 115 may determine an indication of configurations for dynamic beam adjustment. For example, the UE 115 may determine beam information to be used for future beam adjustment by dynamic triggering or signaling. Additionally, or alternatively, the UE 115 may determine channel management resource information, such as from channel measurement resource data 408 included in or indicated by the configuration message 452.

The base station 105 transmits a signaling message 454 including an indication for a dynamic beam adjustment. The signaling message 454 may include or correspond to a dynamic beam adjustment message. In some implementations, the signaling message 454 comprises a PDCCH transmission, such as DCI. In some other implementations, the signaling message 454 comprises a MAC-CE. The signaling message 454 may indicate (trigger or activate) a CSI report to be transmitted by the UE 115. For example, the signaling message 454 may indicate or include a CSI activation command, such as an activation command for a particular type of CSI, aperiodic, semi-periodic, periodic, etc.

The signaling indication may indicate or identify adjusted second beam information. In some implementations, the second beam information is included in the signaling message 454. In other implementations, the second beam information is indicated in signaling message 454. In a particular implementation, the signaling message 454 include CSI state information, such as CSI triggering or activation state information. This CSI state information may be included in a CSI request field of DCI or a MAC-CE. The CSI state information may be associated with or linked to channel resource management information. For example, the CSI state information may indicate or identify one or more identifiers (IDs) of channel management resource sets (or resources thereof). Examples of such associations and linking are illustrated and described further with reference to FIGS. 5-10B.

The UE 115 may receive the signaling message 454 and may perform one or more evaluations or determinations on the signaling message 454 or using the signaling message 454. The UE 115 may determine a dynamic adjustment to the current beam information, and optionally, may determine a duration of the dynamic adjustment, such as for how long the adjustment is valid. The UE 115 obtains second beam information based on the indication of the signaling message 454. In some implementations, the UE 115 sets the second beam information as the current information, such as by modifying the first beam information to the second beam information.

The UE 115 may perform one or more operations based on the dynamic beam information. For example, the UE 115 may transmit or receive a transmission using the second beam information. As another example, the UE 115 may perform one or more measurements using the second beam information and may report the measurement information and/or the second beam information. Additionally, or alternatively, the UE 115 may utilize the second beam information in one or more artificial intelligence (AI) or machine learning (ML) processes, such as AI- or ML-assisted predictive beam management operations. Such AI/ML assisted predictive beam management operations may include or correspond to AI/ML based time domain Beam Prediction or AI/ML based frequency domain Beam Prediction.

As illustrated in the example of FIG. 4, the UE 115 transmits a transmission 456 using the second beam information as an illustrative operation performed based on the second beam information. For example, the UE 115 may transmit a PUCCH and/or PUSCH transmission using the second beam information. In a particular implementation, the UE 115 transmits a CSI report, the CSI report including measurement information generated using the second beam information or generated based on the measurement information. The CSI report may be activated or triggered by the signaling message 454 in some implementations. Although a transmission 456 is illustrated in the example of FIG. 4, in other implementations, one or more other processes are performed in addition to or in the alternative of the transmission 456.

Accordingly, the network (e.g., the base station 105 and the UE 115) may be able to more efficiently and more quickly adjust beam information, such as beam shape and/or beam neighbor information. Dynamic beam adjustment may reduce beam failure and radio link failure and reduce or prevent the use of recovery operations due to beam or link failure. Additionally, dynamic beam adjustment may reduce errors and latency and increase throughput.

Referring to FIG. 5, FIG. 5 is a timing diagram illustrating a wireless communication system that supports dynamic alteration of beam information according to one or more aspects. The example of FIG. 5 may include or correspond to an example of dynamic beam adjustment for DCI triggered aperiodic CSI operations.

At 510, the base station 105 transmits a first RRC configuration including beam shape information and/or beam neighbor information (also referred to as beam neighboring information). For example, the base station 105 transmits a RRC configuration message including channel management resource information and beam information associated with resources (or sets of resources) of the channel management resource information. The beam information may include beam shape information and/or beam neighbor information corresponding to one or more beams, such as a first beam, a second beam, etc.

At 515, the UE 115 receives the RRC configuration and determines information for a first beam, first beam information, based on the beam shape information and/or beam neighbor information.

From 520 to 560, the UE 115 performs a first set of operations. The operations may include transmitting or receiving communications based on the first beam, such as by using the first beam information for a least a portion of the operations. The operations may include using the first beam information as an input or inference for AI or ML based beam prediction or estimation, using the first beam to report information in a CSI report, or a combination thereof.

At 525, the base station 105 may determine to use another beam, such as based on UE 115 feedback. For example, the base station 105 may determine to use another beam based on the one or more operations. To illustrate, the base station 105 may receive information from the UE 115 which indicates, implicitly or explicitly, channel quality is or has decreased, or that it is estimated that channel quality will decrease in the future. In a particular implementation, the base station 105 determines the new beam based on AI or ML and prior to beam failure or radio link failure.

At 530, the base station 105 transmits a DCI transmission including an indication of a change in current beam information. The DCI transmission may include or correspond to an uplink grant DCI or an enhanced downlink grant DCI, and may correspond to a DCI triggered aperiodic CSI report. The DCI transmission may include CSI request information, such as a CSI request field. The CSI request information may indicate a triggered CSI state (aperiodic CSI triggering state information) of a set of configured CSI states configured by RRC.

The CSI request information may indicate a change in beam information, a beam to change to, or both. In a particular implementation, the CSI request information implicitly indicates information for the new/adjusted beam based on linking a triggered CSI state (aperiodic CSI triggering state information) included in or indicated by the CSI request field to beam information previously configured by RRC, such as in the RRC configuration of 510.

At 535, the UE 115 receives the DCI transmission and determines information for a second beam based on the indication. The UE 115 may switch from the first beam information to second beam information based on the indication. In a particular implementation, the UE 115 may modify the current beam information from the first beam information to second beam information based on the indication.

In some implementations, the indication includes or corresponds to an aperiodic CSI triggered state indication. For example, the dynamically changed beam shape and/or neighboring information is identified based on a preconfigured aperiodic CSI triggering state indicated by the CSI request field of the DCI.

In some such implementations, the DCI (e.g., the CSI request field) includes one or more CSI report information elements, such as one or more information elements of CSI-AssociatedReportConfigInfo. At least one of the CSI report information elements (e.g., one of the CSI-AssociatedReportConfigInfo information elements) associated with the preconfigured CSI triggering state includes at least one channel management resource (CMR) set ID. The CMR set ID may be associated with beam shape and/or neighboring information, such as the beam information received by the RRC configuration message. The UE 115 may then determine the second beam based on the beam shape and/or neighboring information associated with the CMR set ID. For example, the associated beam information may correspond to the second beam information, and the UE 115 may utilize the second beam information based on the CMR set ID, which was identified based on the triggered CSI state.

In a particular implementation, this determination of the second beam and/or second beam information can be further based on the RRC configuration of the CMR set. For example, the RRC configured CMR set may include multiple beam shape and/or neighboring beam options, while the CSI-AssociatedReportConfigInfo information element indicates one of them. In some such examples, the multiple beam shape or neighboring information options may include a default option. The default option may be used for a particular CMR set ID, multiple CMR set IDs, or when no CMR set ID or linking information is provided.

Alternatively, the CMR set may include one beam shape or neighboring information option, such as a default option, and the CSI-AssociatedReportConfigInfo may indicate explicitly (e.g., may include) beam shape and/or neighbor information. The explicitly indication may correspond to an alternative option or options to the default option associated with the CMR set.

Thus, the UE 115 may determine beam shape and/or neighboring information (or characteristics thereof) based on respective CMRs within the CMR set included or indicated by the CSI-AssociatedReportConfigInfo, based on the beam shape/neighboring info comprised by the CSI-AssociatedReportConfigInfo, or both, when measuring the CMR set, such as for the CSI report indicated by the DCI.

In some implementations, the UE 115 uses the information included in the DCI to overwrite or modify information of the CRM set, such as a periodic or semi-periodic CMR set. For example, the DCI may include the second beam information, and the UE 115 modifies beam information of the CMR set to be or include the second beam information.

Examples of dynamic beam adjustment are described further with reference to FIG. 9. Referring to FIG. 9, FIG. 9 depicts three example indications for beam shape and/or neighboring information.

A first example 902 illustrates indication by an indicator in the DCI which is configured to identify the beam shape and/or neighbor information based on the CSI-AssociatedReportConfigInfo information element and associated triggering states and independent of RRC configuration (e.g., independent of an IE configured by RRC).

A second example 904 illustrates indication by inclusion of second beam information (or an indication therefore) in the DCI which can overwrite beam information configured by RRC (and optionally by prior dynamic adjustment). For example, the CSI-AssociatedReportConfigInfo information element includes dynamic beam information for which is configured to modify beam shape and/or neighbor information of an RRC configured information element. The information included in the CSI may include beam information for a CMR set, CMR sets, or resources thereof. The beam information may be associated with or linked with one or more CMR set IDs.

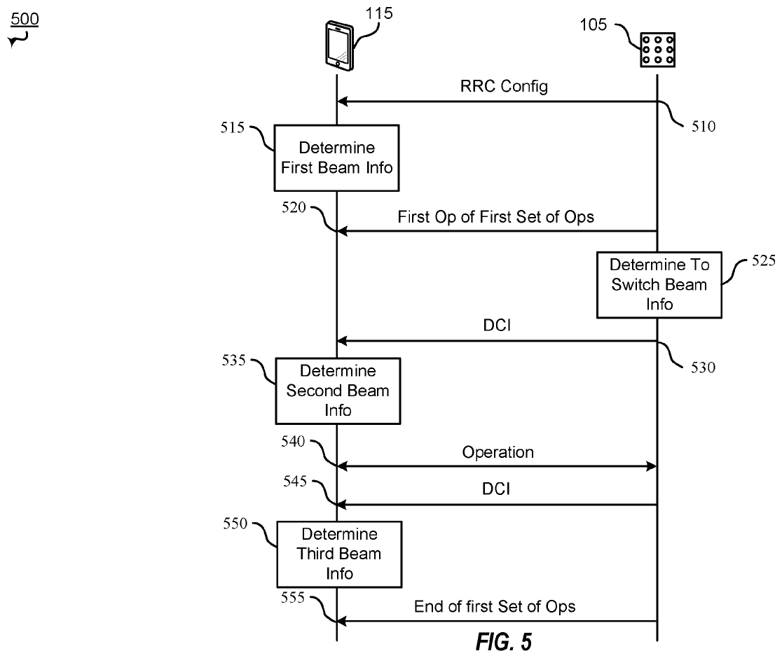

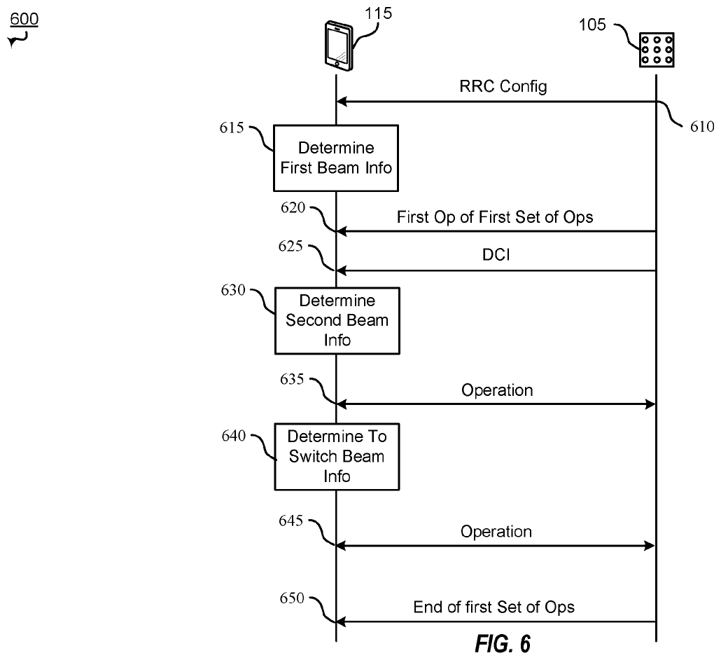

A third example 906 illustrates indication by an indicator in the DCI which links to beam information configured by RRC (and optionally by prior dynamic adjustment). For example, the CSI-AssociatedReportConfigInfo information element identifies a CMR set, such as by CMR set ID, which has corresponding beam information for dynamic adjustment. The examples 902-906 of FIG. 9 may also apply to FIGS. 6 and 7.

Additionally, or alternatively, the UE 115 may determine a duration of the dynamic beam adjustment. For example, the UE 115 may determine that the second beam information applies for one operation, such as only applies for the instance or resources used to determine the measurement results for the CSI report indicated by the DCI. As another example, the UE 115 may determine that the second beam information applies for all subsequent received instances of the CMR set, such as the periodic or semi-periodic CMR set (P/SP CMR set).

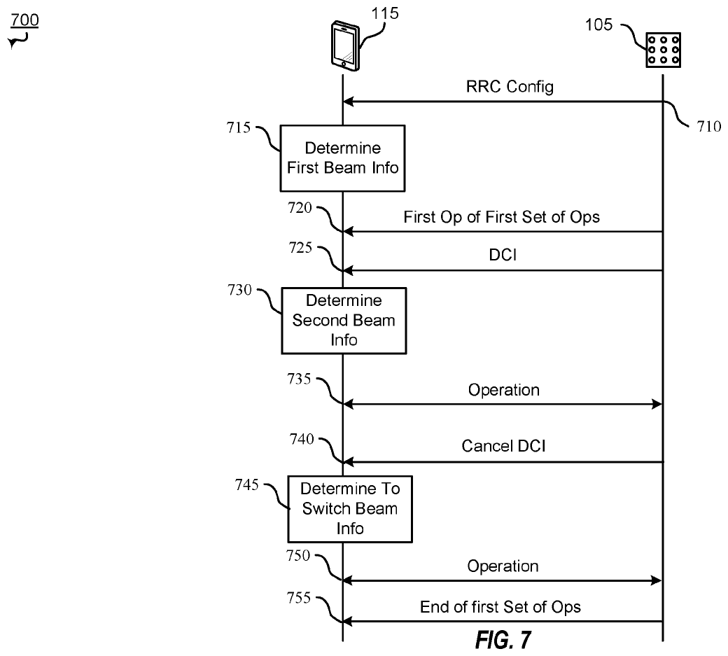

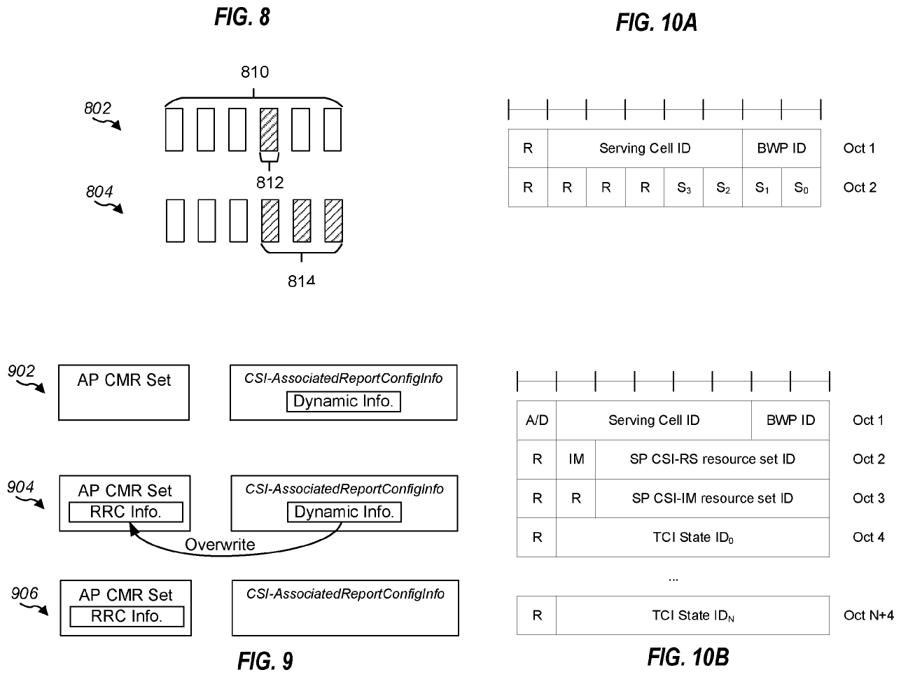

Examples of a duration of the dynamic beam adjustment are described further with reference to FIG. 8. Referring to FIG. 8, FIG. 8 depicts two example durations for beam shape and/or neighboring information.

A first example 802 illustrates dynamic beam information with a duration of a single instance of a P/SP CMR set, such as for a duration associated with a CSI report activated or triggered by the DCI or MAC-CE.

A second example 804 illustrates dynamic beam information with a duration of multiple instances of a P/SP CMR set. In the second example 804, the duration is for all subsequent instances of the P/SP CMR set, such as for a duration associated with each subsequent CSI report associated with the P/SP CMR set. The examples 802 and 804 of FIG. 8 may also apply to FIGS. 6 and 7.

In addition to the examples of FIG. 8, other durations may be used, such as a duration expressed in time. As illustrative examples, the duration may be expressed in slots, milliseconds, etc. For example, if the dynamic beam adjustment indication is included in a MAC-CE, a UE may determine that the dynamic beam adjustment (e.g., second beam information) is to be valid for X slots or Y milliseconds after an acknowledgement message (e.g., ACK) for the MAC-CE is sent by the UE, where X is a positive integer and Y is greater than zero. As illustrative, non-limiting examples, X may be 1, 2, 4, 10, 20, etc., and Y may be 0.5, 1, 2, 3, 5, etc.

As another example, if the dynamic beam adjustment indication is included in a DCI, the UE may determine the dynamic beam adjustment (e.g., second beam information) to be valid for a duration which has: 1) a start time X of slots or Y milliseconds after the receipt of the DCI transmission and an end time of an end of the remaining configured periodic or semi-periodic channel measurement resources; 2) a start time X slots or Y milliseconds after the receipt of the DCI transmission and an end time W slots or Z milliseconds after the receipt of the DCI; or 3) a start time X slots or milliseconds after the receipt of the DCI transmission and persisting for all subsequent instances of the CMR set.

In some implementations, a aperiodic channel management resource set indicates the beam shape and/or neighboring information. In some such implementations, the beam shape and/or neighboring information is indicated by the CSI-AssociatedReportConfigInfo associated different triggering states. For example, the RRC configured information element of the aperiodic CMR set may not include beam information, and rather the indication is based on the DCI alone.

Alternatively, the RRC configured information element of the aperiodic CMR set may include beam information. In some such implementations, the DCI may also include beam information. For example, a CSI-AssociatedReportConfigInfo information element associated with an aperiodic CSI triggering state of the DCI may also include beam shape and/or neighboring with respect to the CMR set and which overwrites the beam information within the RRC configured information element of the CMR set. In some other implementations, the DCI does not include beam shape or beam neighbor information and the second beam information is determined based on the RRC configured information element of the CMR set alone, and the CMR set is identified based on the DCI.

At 540, the UE 115 performs one or more first operations, of the first set of operations, based on the second beam. For example, the UE 115 transmits or receives a communication using the second beam, performs a measurement using the second beam, reports the second beam or channel information associated with the second beam, uses information associated with the second beam as an input into a AI or ML beam estimation or selection process, or a combination thereof.

At 545, the base station 105 transmits a second DCI transmission including an indication of a change in current beam information. For example, the base station 105 may transmit a second dynamic adjustment of beam information. The second adjustment may indicate to revert to a previous beam, change to a default beam, or change to a new beam (e.g., unused for the set of operations).

At 550, the UE 115 receives the second DCI transmission and determines information for a third beam based on the indication. The UE 115 may switch from the second beam information to third beam information based on the indication. In a particular implementation, the UE 115 may modify the current beam information from the second beam information to the third beam information based on the indication. In some implementations, the third beam information is the same as the first beam information. For example, the base station 105 may transmit an indication to return to the previous beam, to return to a default beam, or to cease using the update or modified beam (i.e., the second beam).

At 555, the UE 115 performs one or more second operations, of the first set of operations, based on the third beam. For example, the UE 115 transmits or receives a communication using the third beam, performs a measurement using the third beam, reports the third beam or channel information associated with the third beam, uses information associated with the third beam as an input into a AI or ML beam estimation or selection process or a combination thereof.

At 560, the base station 105 and the UE 115 cease performing the first set of operations. For example, resources configured or assigned by the RRC configuration may expire or the base station 105 may deactivate, cancel, or reconfigure the resources. Additionally, or alternatively, the base station 105 may provide or assign new resources, second resource information indicating second resources, in a second RRC configuration message.

Referring to FIG. 6, FIG. 6 is a timing diagram illustrating a wireless communication system that supports dynamic alteration of beam information according to one or more aspects. As compared to the aperiodic example of FIG. 5, the example of FIG. 6 may include or correspond to semi-periodic or periodic examples (e.g., semi-persistent or persistent examples). The example of FIG. 6 may include or correspond to an example of dynamic beam adjustment for DCI triggered periodic or semi-periodic CSI operations. For example, the beam information may be dynamically adjusted via DCI Based SP-CSI activation, such as based on DCI indication of semi-periodic/semi-persistent CSI triggering states.

At 610, the base station 105 transmits a first RRC configuration including beam shape information and/or beam neighbor information (also referred to as beam neighboring information). For example, the base station 105 transmits a RRC configuration message including channel management resource information and beam information associated with resources (or sets of resources) of the channel management resource information. The beam information may include beam shape information and/or beam neighbor information corresponding to one or more beams, such as a first beam, a second beam, etc.

At 615, the UE 115 receives the RRC configuration and determines information for a first beam, first beam information, based on the beam shape information and/or beam neighbor information.

From 620 to 650, the UE 115 performs a first set of operations. The operations may include transmitting or receiving communications based on the first beam, such as by using the first beam information for a least a portion of the operations. The operations may include using the first beam information as an input or inference for AI or ML based beam prediction or estimation.

Optionally, the base station 105 may determine to use another beam, such as described with reference to 515 of FIG. 5. At 625, the base station 105 transmits a DCI transmission including an indication of a change in current beam information. The DCI transmission may include or correspond to an uplink grant DCI or an enhanced downlink grant DCI, and may correspond to a DCI triggered semi-periodic (e.g., semi-persistent) CSI report, SP-CSI. The DCI transmission may include CSI request information, such as a CSI request field. The CSI request information may indicate a triggered CSI state (semi-persistent CSI triggering state information) of a set of configured CSI states configured by RRC.

At 630, the UE 115 receives the DCI transmission and determines information for a second beam based on the indication. The UE 115 may switch from the first beam information to second beam information based on the indication. In a particular implementation, the UE 115 may modify the current beam information from the first beam information to second beam information based on the indication.

In some implementations, the indication includes or corresponds to a semi-periodic (e.g., semi-persistent) CSI triggered state indication. For example, the dynamically changed beam shape and/or neighboring information is identified based on a preconfigured CSI triggering state indicated by the CSI request field of the DCI.

In some such implementations, the DCI (e.g., the CSI request field) includes one or more CSI report information elements, such as one or more information elements of CSI-SemiPersistentOnPUSCH-TriggerState. At least one of the CSI-SemiPersistentOnPUSCH-TriggerState information elements associated with the preconfigured CSI triggering state includes at least one channel management resource (CMR) set ID. The CMR set ID may be associated with beam shape and/or neighboring information. The UE 115 may then determine the second beam based on the beam shape and/or neighboring information associated with the CMR set ID. For example, the associated beam information may correspond to the second beam information, and the UE 115 may utilize the second beam information based on the CMR set ID, which was identified based on the triggered CSI state.

In a particular implementation, this determination of the second beam and/or second beam information can be further based on the RRC configuration of the CMR set. For example, the RRC configured CMR set may include multiple beam shape/neighboring options, while the CSI-SemiPersistentOnPUSCH-TriggerState indicates one of them. In some such examples, the multiple beam shape or neighboring information options may include a default option. The default option may be used for a particular CMR set ID, multiple CMR set IDs, or when no CMR set ID or linking information is provided.

Alternatively, CMR set may include one beam shape or neighboring information option, such as a default option, and the CSI-SemiPersistentOnPUSCH-TriggerState may indicate explicitly (e.g., may include) beam shape and/or neighbor information. The explicitly indication may correspond to an alternative option or options to the default option associated with the CMR set.

Thus, the UE 115 may determine beam shape and/or neighboring information (or characteristics thereof) based on respective CMRs within the CMR set included or indicated by the CSI-SemiPersistentOnPUSCH-TriggerState, based on the beam shape/neighboring info comprised by the CSI-SemiPersistentOnPUSCH-TriggerState, or both, when measuring the CMR set, such as for the CSI report indicated by the DCI.

In some implementations, the UE 115 uses the information included in the DCI to overwrite or modify information of the CRM set, such as a periodic or semi-periodic CMR set. For example, the DCI may include the second beam information, and the UE 115 modifies beam information of the CMR set to be or include the second beam information.

Additionally, or alternatively, the UE 115 may determine a duration of the dynamic beam adjustment. For example, the UE 115 may determine that the second beam information applies for one operation, such as only applies for the instance or resources used to determine the measurement results for the CSI report indicated by the DCI. As another example, the UE 115 may determine that the second beam information applies for all subsequent received instances of the CMR set, such as the periodic or semi-periodic CMR set (P/SP CMR set).

In some implementations, a channel management resource set indicates the beam shape and/or neighboring information. In some such implementations, the beam shape and/or neighboring information is indicated by the CSI-SemiPersistentOnPUSCH-TriggerState and its associated triggering states. For example, the RRC configured information element of the CMR set may not include beam information, and rather the indication is based on the DCI alone.

Alternatively, the RRC configured information element of the CMR set may include beam information. In some such implementations, the DCI may also include beam information. For example, a CSI-SemiPersistentOnPUSCH-TriggerState information element associated with a semi-periodic (e.g., semi-persistent) CSI triggering state of the DCI may also include beam shape and/or neighboring information with respect to the CMR set and which overwrites the beam information within the RRC configured information element of the CMR set. In some other implementations, the DCI does not include beam shape or beam neighbor information and the second beam information is determined based on the RRC configured information element of the CMR set alone, and the CMR set is identified based on the DCI.

At 635, the UE 115 performs one or more first operations, of the first set of operations, based on the second beam. For example, the UE 115 transmits or receives a communication using the second beam, performs a measurement using the second beam, reports the second beam or channel information associated with the second beam, uses information associated with the second beam as an input into a AI or ML beam estimation or selection process, or a combination thereof.

At 640, the UE 115 determines information for a third beam. The UE 115 may switch from the second beam information to third beam information based on the determination. In a particular implementation, the UE 115 may modify the current beam information from the second beam information to third beam information based on the indication. In some implementations, the third beam information is the same as the first beam information. For example, the base station 105 may transmit an indication to return to the previous beam, to return to a default beam, or to cease using the update or modified beam (i.e., the second beam).

In some implementations, the base station 105 transmits a second DCI transmission including an indication of a change in current beam information. For example, the base station 105 may transmit a second dynamic adjustment of beam information. The second adjustment may indicate to revert to a previous beam, a default beam, or a new beam (e.g., unused for the set of operations). As another example, the base station 105 may transmit another type of message, such as a different type of DCI or a MAC-CE to end or cancel the dynamic adjustment. The UE 115 then determines the third beam information based on the second DCI transmission.

Additionally, or alternatively, the UE 115 determines a duration of the first dynamic adjustment of the second beam. For example, the UE 115 may determine the duration based on the RRC configuration message, the DCI, or both. Conversely, the UE 115 may assume or be preconfigured with a duration. The duration may include a single instance, multiple instances, or all instances. The UE 115 then may determine the third beam information, such as to change to a default beam or revert to a previous beam (first beam), based on the determined duration of the validity of the second beam information.

In some implementations, the UE 115 is configured to modify or overwrite beam information of the P/SP CMR set based on the second beam information of the DCI. In some such implementations, the second beam information applies only for the instance or instances (e.g., resource or resources) used to determine the measurement for the SP CSI report indicated by the DCI and/or until it is deactivated by the cancel transmission, such as MAC-CE or DCI. In other such implementations, the second beam information applies for all subsequent received instances of the P/SP CMR set. In a particular implementation, a cancel transmission may not be configured to be used by the network or may not be received by the UE 115.

At 645, the UE 115 performs one or more second operations, of the first set of operations, based on the third beam. For example, the UE 115 transmits or receives a communication using the third beam, performs a measurement using the third beam, reports the third beam or channel information associated with the third beam, uses information associated with the third beam as an input into a AI or ML beam estimation or selection process, or a combination thereof.

At 650, the base station 105 and the UE 115 cease performing the first set of operations. For example, resources configured or assigned by the RRC configuration may expire or the base station 105 may deactivate, cancel, or reconfigure the resources. Additionally, or alternatively, the base station 105 may provide or assign new resources, second resource information indicating second resources, in a second RRC configuration message.

Referring to FIG. 7, FIG. 7 is a timing diagram illustrating a wireless communication system that supports dynamic alteration of beam information according to one or more aspects. As compared to the DCI based examples of FIGS. 5 and 6, the example of FIG. 7 may include or correspond to a MAC-CE based example. For example, the MAC-CE example of FIG. 7 may include or correspond to dynamic adjustment based on a MAC-CE activated SP CSI report (e.g., MAC-CE Based SP-CSI Activation).

At 710, the base station 105 transmits a first RRC configuration including beam shape information and/or beam neighbor information (also referred to as beam neighboring information). For example, the base station 105 transmits a RRC configuration message including channel management resource information and beam information associated with resources (or sets of resources) of the channel management resource information. The beam information may include beam shape information and/or beam neighbor information corresponding to one or more beams, such as a first beam, a second beam, etc.

At 715, the UE 115 receives the RRC configuration and determines information for a first beam, first beam information, based on the beam shape information and/or beam neighbor information of the beam information of the RRC configuration.

From 720 to 755, the UE 115 performs a first set of operations. The operations may include transmitting or receiving communications based on the first beam, such as by using the first beam information for a least a portion of the operations. The operations may include using the first beam information as an input or inference for AI or ML based beam prediction or estimation.

Optionally, the base station 105 may determine to use another beam, such as described with reference to 515 of FIG. 5. At 725, the base station 105 transmits a MAC-CE transmission including an indication of a change in current beam information. The MAC-CE transmission may include or correspond to an activation MAC-CE and configured to activate a CSI report. The MAC-CE transmission may include CSI request information, such as a CSI request field. For example, the MAC-CE may identify resources and/or configurations for CSI measurement and reporting. This CSI information may indicate state information which is linked with a set of configured CSI states configured by RRC or an indication of a CMR set identifier.

The indication for a change in current beam information (dynamic beam adjustment) may include or correspond to an indicator configured to identify the second beam information. The second beam information may be associated with a CMR set linked with the activated CSI report, and the indication or indicator may identify the CMR, such as be CMR set ID, for the activated CSI report. Alternatively, the MAC-CE may include the second beam information.

In some implementations, the MAC-CE includes or corresponds to a SP-CSI report activation MAC-CE or to a SP-CSI resource set activation MAC-CE. In some such implementations, the indicator of the MAC-CE may include or correspond to reserved bits of a conventional SP-CSI report activation MAC-CE format, reserved bits of a conventional SP-CSI resource set activation MAC-CE format, a field of a dedicated SP-CSI report activation MAC-CE format for dynamic alteration of beam information, a field of a dedicated SP-CSI resource set activation MAC-CE format for dynamic alteration of beam information. As used herein, the reserved bits of the SP-CSI report activation MAC-CE and the SP-CSI resource set activation MAC-CE may include or correspond to reserve bits (denoted by ‘R’) in the examples of FIGS. 10A and 10B respectively.

In some other such implementations, the reserved bits or the field of the MAC-CE include the second beam information. For example, the MAC-CE include a field which includes the second beam information or indicated the second beam information explicitly, such as without retrieving the second beam information from RRC configured beam information.

At 730, the UE 115 receives the MAC-CE transmission and determines information for a second beam based on the indication. The UE 115 may switch from the first beam information to second beam information based on the indication. In a particular implementation, the UE 115 may modify the current beam information from the first beam information to second beam information based on the indication.

At 735, the UE 115 performs one or more first operations, of the first set of operations, based on the second beam. For example, the UE 115 transmits or receives a communication using the second beam, performs a measurement using the second beam, reports the second beam or channel information associated with the second beam, uses information associated with the second beam as an input into a AI or ML beam estimation or selection process, or a combination thereof.

At 740, the base station 105 transmits a cancel indication for the dynamic beam adjustment. For example, the base station 105 may transmit a DCI or MAC-CE indicating a cancelation of the dynamically adjusted beam information, the second beam information. The DCI or MAC-CE may include or correspond to a particular type or format, such as a cancelation of dynamic beam adjustment format. Alternatively, the DCI or MAC-CE may include an indicator configured to identify cancelation of a particular dynamic beam adjustment or cancelation of multiple, such as all, dynamic beam adjustments.

At 745, the UE 115 determines to switch to the first beam based on the cancel indication. The UE 115 may switch from the second beam information to first beam information based on the cancel indication. In a particular implementation, the UE 115 may modify the current beam information from the second beam information to first beam information based on the indication.

In other implementations, the UE 115 determines a duration of the first dynamic adjustment of the second beam. For example, the UE 115 may determine the duration based on the RRC configuration message, the MAC-CE, or both. Alternatively, the UE 115 may assume or be preconfigured with a duration. The duration may include a single instance, multiple instances, or all instances. The UE 115 then determines the third beam information based on the determined duration of the validity of the second beam information.

In some implementations, the UE 115 is configured to modify or overwrite beam information of the P/SP CMR set based on second beam information of the MAC-CE. In some such implementations, the second beam information applies only for the instance or instances (e.g., resource or resources) used to determine the measurement for the SP CSI report indicated by the MAC-CE and/or until it is deactivated by the cancel transmission, such as MAC-CE or DCI. In other such implementations, the second beam information applies for all subsequent received instances of the P/SP CMR set. In a particular implementation, a cancel transmission may not be configured to be used by the network or may not be received by the UE 115.

At 750, the UE 115 performs one or more second operations, of the first set of operations, based on the first beam (or the third beam). For example, the UE 115 transmits or receives a communication using the first beam, performs a measurement using the first beam, reports the first beam or channel information associated with the first beam, uses information associated with the first beam as an input into a AI or ML beam estimation or selection process, or a combination thereof.

At 755, the base station 105 and the UE 115 cease performing the first set of operations. For example, resources configured or assigned by the RRC configuration may expire or the base station 105 may deactivate, cancel, or reconfigure the resources. Additionally, or alternatively, the base station 105 may provide or assign new resources, second resource information indicating second resources, in a second RRC configuration message.

Although the examples of FIGS. 5-7 are described with reference to an indication in a CSI request field, in other implementations the beam information may be adjusted based on one or more other fields of a MAC-CE or DCI, that is a field other than or in addition to a CSI request field.

A CMR set, such as a configured P/SP CMR set, may include beam shape information which has been obtained by RRC configuration or prior dynamic adjustment. The UE may receive an explicit indication of new beam shape or neighbor information associated with one or multiple CMRs within the CMR set. In a particular implementation, the MAC-CE or DCI includes the new beam information. For example, the MAC-CE or DCI includes at least one of an ID of the P/SP CMR set, ID(s) of CMRs of a CMR set, and the new beam shape pr neighbor information associated with the CMRs.

In a particular implementation, the new beam shape and/or neighbor information can be differentially indicated referred to the currently identified beam shape/neighboring info associated with respective CMRs. For example, a difference or delta value representing a change in a beam point angle may be indicated in the MAC-CE or DCI.

Although the above examples have been described with reference to channel management resources, in other implementations the network may perform dynamic beam adjustment based on interference management resource information. For example, the UE 115 may utilize interference management resource (IMR) set information, including CSI-RS or CSI-IM resources. To illustrate, the UE 115 may determine a dynamic beam adjustment based on a received indication identifying second beam information which is associated with an IMR set (e.g., IMR set ID) or based on received second beam information which is associated with an IMR set. The association may include IMR set identification information for either CSI-RS, CSI-IM, or both.

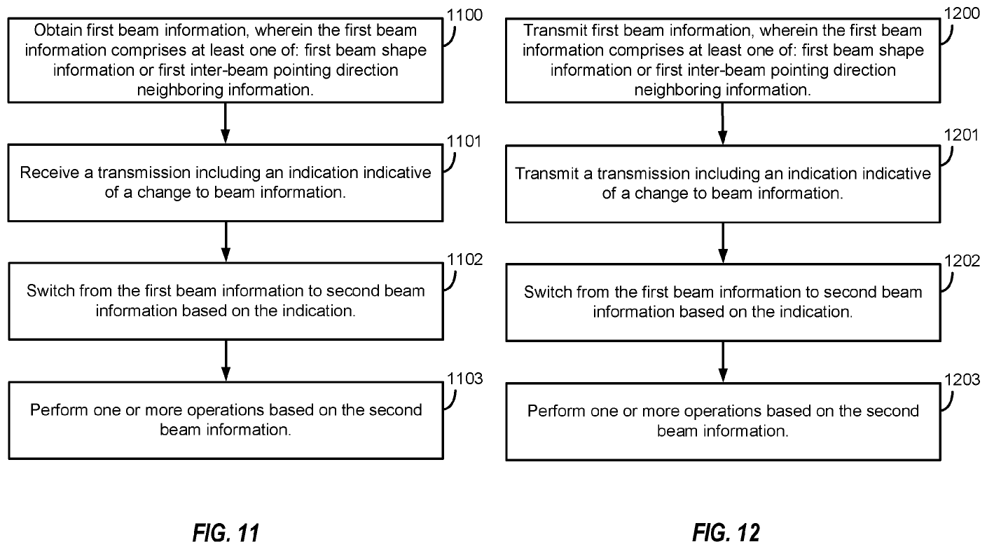

FIG. 11 is a flow diagram illustrating example blocks executed by a wireless communication device (e.g., a UE or base station) configured according to an aspect of the present disclosure. The example blocks will also be described with respect to UE 115 as illustrated in FIG. 13. FIG. 13 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1301a-r and antennas 252a-r. Wireless radios 1301a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 13, memory 282 stores dynamic beam adjustment logic 1302, CSI report logic 1303, AI/ML logic 1304, beam information data 1305, CMR data 1306, dynamic indication data 1307, and settings data 1308. The data (1302-1308) stored in the memory 282 may include or correspond to the data (406, 408, 442, and/or 444) stored in the memory 404 of FIG. 4.

At block 1100, a wireless communication device, such as a UE, obtains first beam information. The first beam information includes at least one of: first beam shape information or first inter-beam pointing direction neighboring information. For example, the UE 115 receives a RRC, a MAC-CE, or DCI including first beam information or an indication for a first beam. The received transmission may include or correspond to the configuration transmission 450 of FIG. 4, the configuration message 452 of FIG. 4, the signaling message 454 of FIG. 4, the RRC configuration messages of FIGS. 5-7, or the DCIs or MAC-CEs of FIGS. 5-7, as described with reference to FIGS. 4-7. To illustrate, a receiver (e.g., receive processor 258 or receiver 412) of the UE 115 receives the configuration message 452, including the channel measurement resource data 408, via wireless radios 1301a-r and antennas 252a-r. Obtaining the first beam information may include receiving the first beam information by RRC configuration or receiving/determining the first beam information from a prior dynamic adjustment, as described with reference to FIGS. 4-7.

At block 1101, the UE 115 receives a transmission including an indication indicative of a change to beam information. For example, the UE 115 transmits or receives a MAC-CE or DCI including an indication to dynamically adjust the first beam information, such as currently or most previously used beam or a planned to be used beam. The received transmission may include or correspond to the signaling message 454 of FIG. 4, or the DCIs or MAC-CEs of FIGS. 5-7, as described with reference to FIGS. 4-7. To illustrate, a receiver (e.g., receive processor 258 or receiver 412) of the UE 115 receives the signaling message 454 via wireless radios 1301a-r and antennas 252a-r which includes an indication of the second beam information or which includes the second beam information itself. When the transmission includes the indication, the indication may identify where the second beam information may be obtained (e.g., include an identifier pointing to a beam information) or how to adjust the first beam information to determine or calculate the second beam information.

At block 1102, the UE 115 switches from the first beam information to second beam information based on the indication. For example, the UE 115 retrieves the second beam information from memory based on the indication in the transmission or calculates the second beam information based on the indication and first beam information. As another example, the UE 115 uses the second beam information included in the transmission. Additionally, or alternatively, the UE 115 may switch from the first beam information to the second beam information as described with reference to FIGS. 4-10B.

At block 1103, the UE 115 performs one or more operations based on the second beam information. For example, the UE 115 performs one or more of the operations as described with reference to FIG. 4. To illustrate, the UE 115 may perform artificial intelligence- or machine learning-assisted beam selection using the second beam information. As another illustration, the UE 115 may perform one or more measurements using the second beam information. As yet another illustration, the UE 115 may transmit a transmission using the second beam information or receive a transmission using the second beam information.

The wireless communication device (e.g., UE or base station) may execute additional blocks (or the wireless communication device may be configured further perform additional operations) in other implementations. For example, the wireless communication device (e.g., the UE 115) may perform one or more operations described above. As another example, the wireless communication device (e.g., the UE 115) may perform one or more aspects as presented below.

In a first aspect, obtaining the first beam information, includes: receiving a radio resource control (RRC) configuration indicating the first beam information; receiving downlink control information (DCI) and determine, based on the DCI, the first beam information; or receiving a medium access control (MAC) control element (CE) (MAC-CE) and determine, based on the MAC-CE, the first beam information.

In a second aspect, alone or in combination with the first aspect, performing the one or more operations includes: performing artificial intelligence- or machine learning-assisted beam selection using the second beam information; performing one or more measurements using the second beam information; transmitting a transmission using the second beam information; receiving a transmission using the second beam information; or reporting the second beam information.

In a third aspect, alone or in combination with one or more of the above aspects, the second beam information comprises at least one of: second beam shape information or second inter-beam pointing direction neighboring information.

In a fourth aspect, alone or in combination with one or more of the above aspects, the second beam shape information comprises at least one of: second beam direction information, second beam weight information, or second beam width information.

In a fifth aspect, alone or in combination with one or more of the above aspects, the second inter-beam pointing direction neighboring information comprises second spatial information.

In a sixth aspect, alone or in combination with one or more of the above aspects, the second spatial information indicates one or more adjacent beams for a particular beam.

In a seventh aspect, alone or in combination with one or more of the above aspects, the first beam shape information comprises at least one of: second beam direction information, second beam weight information, or second beam width information.

In an eighth aspect, alone or in combination with one or more of the above aspects, the first inter-beam pointing direction neighboring information comprises first spatial information.

In a ninth aspect, alone or in combination with one or more of the above aspects, the first spatial information indicates one or more adjacent beams for a particular beam.

In a tenth aspect, alone or in combination with one or more of the above aspects, the transmission comprises downlink control information (DCI) or a medium access control (MAC) control element (CE) (MAC-CE).

In an eleventh aspect, alone or in combination with one or more of the above aspects, the transmission comprises downlink control information (DCI), wherein the DCI includes a triggering command for an aperiodic channel state information (CSI) report, and wherein the at least one processor is configured to: determine the second beam information based on the aperiodic CSI triggering state information of the DCI.

In a twelfth aspect, alone or in combination with one or more of the above aspects, the CSI report is an aperiodic CSI report, and wherein the aperiodic CSI triggering state information is included in a CSI request field of the DCI and the DCI includes a plurality of CSI report information elements associated with the aperiodic CSI triggering state information, and wherein at least one CSI report information element of the plurality of CSI report information elements comprises at least one channel management resource set identifier and beam information associated with the channel management resource set.

In a thirteenth aspect, alone or in combination with one or more of the above aspects, the network node (e.g., UE 115) further: determines that the second beam information corresponds to a single instance of a configured periodic or semi-periodic channel management resource set; and switches from the second beam information to the first beam information, after the performance of the one or more processes for the single instance, for subsequent instances of the configured periodic or semi-periodic channel management resource set.

In a fourteenth aspect, alone or in combination with one or more of the above aspects, the network node (e.g., UE 115) further: determine that the second beam information corresponds to each respective instance of a plurality of instances of a configured periodic or semi-periodic channel management resource set; and transmit channel state information (CSI) report information for the plurality instances of the configured periodic or semi-periodic channel management resource set using the second beam information.

In a fifteenth aspect, alone or in combination with one or more of the above aspects, the network node (e.g., UE 115) further: receives an RRC message including an information element for a channel management resource set associated with the aperiodic CSI triggering state information, wherein the information element does not indicate beam information for dynamic adjustment or the first beam information, and where obtaining the first beam information includes: receiving, prior to the receipt of the transmission, a second transmission which includes the first beam information, and wherein the transmission includes the second beam information.

In a sixteenth aspect, alone or in combination with one or more of the above aspects, obtaining the first beam information includes: receiving an RRC message including an information element for a channel management resource set associated with the aperiodic CSI triggering state information, wherein the information element includes the first beam information, and wherein the transmission includes the second beam information.

In a seventeenth aspect, alone or in combination with one or more of the above aspects, obtaining the first beam information includes: receiving an RRC message including an information element for a channel management resource set associated with the aperiodic CSI triggering state information, wherein the information element includes the first beam information and the second beam information, and wherein the transmission includes a channel management resource set identifier configured to identify the second beam information of the information element.

In an eighteenth aspect, alone or in combination with one or more of the above aspects, the transmission includes downlink control information (DCI), wherein the DCI includes an activation command for a semi-persistent channel state information (CSI) report and semi-persistent CSI triggering state information, and determining the second beam information based on the semi-persistent CSI triggering state information includes: determining the second beam information based on the semi-persistent CSI triggering state information.

In a nineteenth aspect, alone or in combination with one or more of the above aspects, the CSI report is a semi-persistent CSI report, and wherein the semi-persistent CSI triggering state is included in a CSI request field of the DCI and the DCI includes a CSI report information element associated with the semi-persistent CSI triggering state information, and wherein the CSI report information element comprises at least one channel management resource set identifier and beam information associated with the channel management resource set.

In a twentieth aspect, alone or in combination with one or more of the above aspects, the network node (e.g., UE 115): determine that the second beam information corresponds to multiple instances of a configured periodic or semi-periodic channel management resource set; use the second beam information for the multiple instances of the configured periodic or semi-periodic channel management resource set; receive a deactivation message for the second beam information during the configured periodic or semi-periodic channel management resource set; switch from the second beam information to the first beam information based on the deactivation message; and use the first beam information for remaining instances of the configured periodic or semi-periodic channel management resource set.

In a twenty-first aspect, alone or in combination with one or more of the above aspects, the network node (e.g., UE 115): determine that the second beam information corresponds to each respective instance of a plurality of instances of a configured periodic or semi-periodic channel management resource set; and transmit channel state information (CSI) report information for the plurality instances of the configured periodic or semi-periodic channel management resource set using the second beam information.

In a twenty-second aspect, alone or in combination with one or more of the above aspects, the transmission includes a medium access control (MAC) control element (CE) (MAC-CE), wherein the MAC-CE includes an activation command for a semi-persistent (SP) channel state information (CSI) (SP-CSI) report, wherein the MAC-CE includes an indication corresponding to the second beam information, and the network node: obtains, based on the indication corresponding to the second beam information, the second beam information from the memory, wherein the second beam information is associated with a configured channel management resource set, and wherein the configured channel management resource set is associated with the SP-CSI report activated by the transmission.

In a twenty-third aspect, alone or in combination with one or more of the above aspects, the MAC-CE comprises a SP-CSI report activation MAC-CE or a SP-CSI resource set activation MAC-CE, and wherein the indicator comprises at least one of: one or more bits corresponding to a first SP-CSI report activation MAC-CE format; one or more bits corresponding to a first SP-CSI resource set activation MAC-CE format; one or more bits corresponding to a second SP-CSI report activation MAC-CE format for dynamic alteration of beam information; or one or more bits corresponding to a second SP-CSI resource set activation MAC-CE format for dynamic alteration of beam information.

In a twenty-fourth aspect, alone or in combination with one or more of the above aspects, the configured channel management resource set comprises a configured periodic or semi-periodic channel management resource set, and the network node: determines that the second beam information corresponds to multiple CSI reports of a configured periodic or semi-periodic channel management resource set; uses the second beam information for at least one CSI report of the multiple CSI reports of the configured periodic or semi-periodic channel management resource set; receives a deactivation message for the second beam information during the configured periodic or semi-periodic channel management resource set; switches from the second beam information to the first beam information based on the deactivation message; and uses the first beam information for remaining CSI reports of the multiple CSI reports.

In a twenty-fifth aspect, alone or in combination with one or more of the above aspects, the configured channel management resource set comprises a configured periodic or semi-periodic channel management resource set, and the network node: determines that the second beam information corresponds to each respective instance of a plurality of instances of a configured periodic or semi-periodic channel management resource set; and transmits CSI report information for the plurality instances of the configured periodic or semi-periodic channel management resource set using the second beam information.

In a twenty-sixth aspect, alone or in combination with one or more of the above aspects, the transmission includes an indication of the second beam information, wherein the indication includes one or more respective identifiers corresponding to one or more respective channel management resources of a channel management resource set, and the network node: determines the second beam information based on the indication of the second beam information.

In a twenty-seventh aspect, alone or in combination with one or more of the above aspects, the transmission includes an indication of the second beam information, wherein the indication includes an identifier corresponding to a channel management resource set, and the network node: determines the second beam information based on the indication of the second beam information.

In a twenty-eighth aspect, alone or in combination with one or more of the above aspects, the second beam information is associated with an identifier, and the identifier corresponds to one or more respective identifiers corresponding to one or more respective channel management resources of a channel management resource set, and the network node: determines the second beam information based on the indication of the second beam information.

In a twenty-ninth aspect, alone or in combination with one or more of the above aspects, the second beam information is differentially indicated in the transmission, and the network node: identifies the second beam information based on the first beam information and a difference indicated by the transmission, wherein the difference identifies a change in value from a second parameter of the second beam information as compared to a first parameter of the first beam information.

In a thirtieth aspect, alone or in combination with one or more of the above aspects, the transmission comprises a medium access control (MAC) control element (CE) (MAC-CE), and the network node: transmits an acknowledgement message indicative of successful receipt of the MAC-CE. The second beam information is valid for: a quantity of slots after the transmission of the acknowledgement message, wherein the quantity is less than or equal to 5; or a time period after the transmission of the acknowledgement message, wherein the time period is less than or equal to 5 milliseconds.

In a thirty-first aspect, alone or in combination with one or more of the above aspects, wherein the transmission comprises a medium access control (MAC) control element (CE) (MAC-CE), and the network node: transmits an acknowledgement message indicative of successful receipt of the MAC-CE, and wherein the second beam information is valid after: a quantity of slots after the transmission of the acknowledgement message, wherein the quantity is less than or equal to 5; or a time period after the transmission of the acknowledgement message, wherein the time period is less than or equal to 5 milliseconds.

In a thirty-second aspect, alone or in combination with one or more of the above aspects, the transmission comprises downlink control information (DCI), and wherein the second beam information is valid: after a first quantity of slots after the receipt of the DCI and until an end of the configured periodic or semi-periodic channel measurement resources, wherein the first quantity is less than or equal to 5; after a second quantity of slots after the receipt of the DCI and until a third quantity of slots after the receipt of the DCI, wherein the second quantity is less than or equal to 3 and the third quantity is less than or equal to 5; or after a fourth quantity of slots after the receipt of the DCI and until a last channel state information (CSI) report of the channel management resource set, wherein the fourth quantity is less than or equal to 5.

In a thirty-third aspect, alone or in combination with one or more of the above aspects, the transmission comprises DCI, and wherein the second beam information is valid: after a first time period after the receipt of the DCI and until an end of the configured periodic or semi-periodic channel measurement resources, wherein the first time period is less than or equal to 5 milliseconds; after a second time period after the receipt of the DCI and until a third time period after the receipt of the DCI, wherein the second time period is less than or 3 milliseconds and the third time period is less than or equal to 5 milliseconds; or after a fourth time period after the receipt of the DCI and until a last channel state information (CSI) report of the channel management resource set, wherein the fourth time period is less than or equal to 5 milliseconds.

In a thirty-third aspect, alone or in combination with one or more of the above aspects, obtaining the first beam information includes: receiving a radio resource control (RRC) message including channel state information (CSI) interference measurement (IM) resources for interference measurement; and determining the first beam information based on the CSI IM resources, and where the network node: determines the second beam information based on at least one of the CSI IM resources or the transmission.

In another aspect, a network node configured for wireless communication includes at least one processor; and a memory coupled to the at least one processor. The at least one processor is configured to: obtain first beam information; receive downlink control information (DCI) including channel state information (CSI) request information, the CSI request information configured to indicate a change to beam information; switch from the first beam information to second beam information based on the CSI request information; and perform one or more operations based on the second beam information.

In another aspect, a network node configured for wireless communication includes at least one processor; and a memory coupled to the at least one processor. The at least one processor is configured to: obtain first beam information; receive a medium access control (MAC) control element (CE) (MAC-CE) transmission including an indication indicative of a change to beam information for a periodic or semi-periodic channel management resource set; switch from the first beam information to second beam information based on the indicator; and perform one or more operations for the periodic or semi-periodic channel management resource set based on the second beam information.

In another aspect, a network node configured for wireless communication includes at least one processor; and a memory coupled to the at least one processor. The at least one processor is configured to: obtain first beam information; receive a transmission including second beam information and including an indication indicative of a change to beam information; modify the beam information based on the second beam information to change from a first beam associated with the first beam information to a second beam associated the second beam information; and perform one or more operations based on the second beam information.

In another aspect, a network node configured for wireless communication includes at least one processor; and a memory coupled to the at least one processor. The at least one processor is configured to: obtain first beam information; receive a transmission including an indication indicative of a change to beam information for an interference management resource set; switch from the first beam information to second beam information based on the transmission; and perform one or more operations for the interference management resource set based on the second beam information.

Accordingly, wireless communication devices may perform enhanced dynamic beam adjustment operations for wireless communication devices. By performing enhanced dynamic beam adjustment throughput can be increased and latency and errors can be reduced.

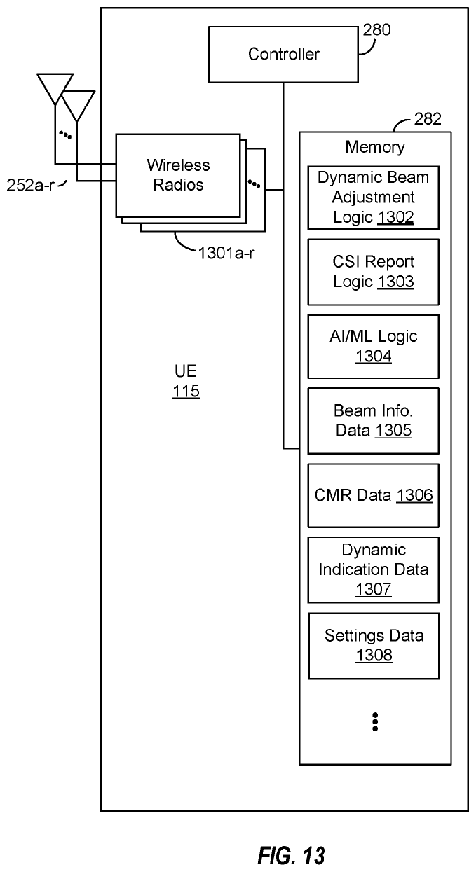

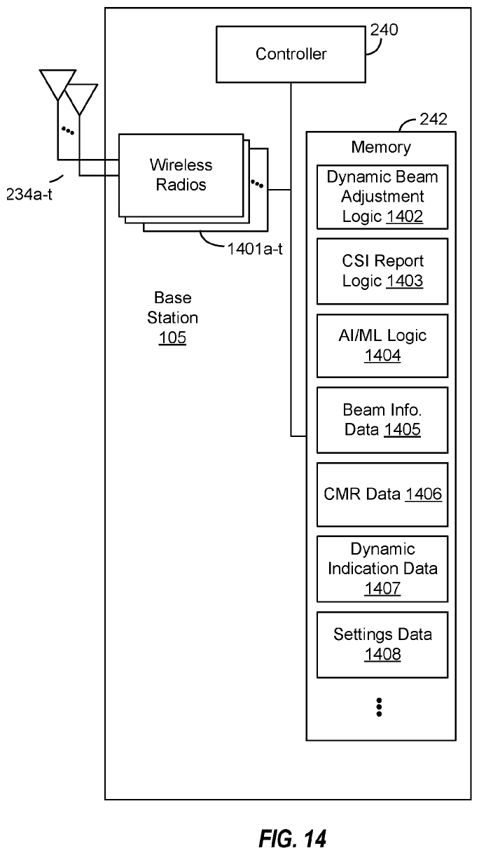

FIG. 12 is a flow diagram illustrating example blocks executed wireless communication device (e.g., a UE or network entity, such as a base station) configured according to an aspect of the present disclosure. The example blocks will also be described with respect to base station 105 as illustrated in FIG. 14. FIG. 14 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1401a-t and antennas 234a-t. Wireless radios 1401a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 14, memory 242 stores dynamic beam adjustment logic 1402, CSI report logic 1403, AI/ML logic 1404, beam information data 1405, CMR data 1406, dynamic indication data 1407, and settings data 1408. The data (1402-1408) stored in the memory 242 may include or correspond to the data (406, 408, 442, and/or 444) stored in the memory 432 of FIG. 4.

At block 1200, a wireless communication device, such as a network device (e.g., a base station 105), transmits first beam information. The first beam information includes at least one of: first beam shape information or first inter-beam pointing direction neighboring information. For example, the base station 105 transmits a RRC, a MAC-CE, or DCI including first beam information or an indication for a first beam. The transmission may include or correspond to the configuration transmission 450 of FIG. 4, the configuration message 452 of FIG. 4, the signaling message 454 of FIG. 4, the RRC configuration messages of FIGS. 5-7, or the DCIs or MAC-CEs of FIGS. 5-7, as described with reference to FIGS. 4-7. To illustrate, a transmitter (e.g., transmit processor 220/TX MIMO processor 230 or transmitter 434) of the base station 105 transmits the configuration message 452, including the channel measurement resource data 408, via wireless radios 1401a-t and antennas 234a-t.

At block 1201, the wireless communication device transmits a transmission including an indication indicative of a change to beam information. For example, the base station 105 transmits a MAC-CE or DCI including an indication to dynamically adjust the first beam information. The transmission may include or correspond to the signaling message 454 of FIG. 4, or one of the DCIs or MAC-CEs of FIGS. 5-7, as described with reference to FIGS. 4-7. To illustrate, a transmitter (e.g., transmit processor 220/TX MIMO processor 230 or transmitter 434) of the base station 105 transmits the signaling message 454, via wireless radios 1401a-t and antennas 234a-t, which includes an indication of the second beam information or which includes the second beam information itself. When the transmission includes the indication, the indication may identify where the second beam information may be obtained (e.g., include an identifier pointing to a beam information) or how to adjust the first beam information to determine or calculate the second beam information.

At block 1202, the wireless communication device switches from the first beam information to second beam information based on the indication. For example, the base station 105 retrieves the second beam information from memory based on the indication in the transmission or calculates the second beam information based on the indication and first beam information. As another example, the base station 105 uses the second beam information included in the transmission. Additionally, or alternatively, the base station 105 may switch from the first beam information to the second beam information as described with reference to FIGS. 4-10B.

At block 1203, the wireless communication device performs one or more operations based on the second beam information. For example, the base station 105 performs one or more of the operations as described with reference to FIG. 4. To illustrate, the base station 105 may perform artificial intelligence- or machine learning-assisted beam selection using the second beam information. As another illustration, the base station 105 may perform one or more measurements using the second beam information. As yet another illustration, the base station 105 may transmit a transmission using the second beam information or receive a transmission using the second beam information.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-9.

In a first aspect, to perform one or more operations based on the second beam information the network node: performs artificial intelligence- or machine learning-assisted beam selection using the second beam information; performs one or more measurements using the second beam information; transmits a transmission using the second beam information; receives a transmission using the second beam information; or reports the second beam information.

In a second aspect, alone or in combination with the first aspect, the transmission comprises downlink control information (DCI), the DCI includes a triggering command for an aperiodic channel state information (CSI) report, and the network node determines the second beam information based on the aperiodic CSI triggering state information of the DCI.

In a third aspect, alone or in combination with one or more of the above aspects, the CSI report is an aperiodic CSI report, and wherein the aperiodic CSI triggering state information is included in a CSI request field of the DCI and the DCI includes a plurality of CSI report information elements associated with the aperiodic CSI triggering state information, and wherein at least one CSI report information element of the plurality of CSI report information elements comprises at least one channel management resource set identifier and beam information associated with the channel management resource set.

In a fourth aspect, alone or in combination with one or more of the above aspects, the transmission comprises downlink control information (DCI), the DCI includes an activation command for a semi-persistent channel state information (CSI) report and semi-persistent CSI triggering state information, and the network node determines the second beam information based on the semi-persistent CSI triggering state information.

In a fifth aspect, alone or in combination with one or more of the above aspects, the CSI report is a semi-persistent CSI report, and wherein the semi-persistent CSI triggering state is included in a CSI request field of the DCI and the DCI includes a CSI report information element associated with the semi-persistent CSI triggering state information, and wherein the CSI report information element comprises at least one channel management resource set identifier and beam information associated with the channel management resource set.

In a sixth aspect, alone or in combination with one or more of the above aspects, the transmission comprises a medium access control (MAC) control element (CE) (MAC-CE), wherein the MAC-CE includes an activation command for a semi-persistent (SP) channel state information (CSI) (SP-CSI) report, the MAC-CE includes an indication corresponding to the second beam information, and the network node: obtains, based on the indication corresponding to the second beam information, the second beam information from the memory, where the second beam information is associated with a configured channel management resource set, and where the configured channel management resource set is associated with the SP-CSI report activated by the transmission.

In a seventh aspect, alone or in combination with one or more of the above aspects, the indication identifies the second beam information, the indication includes one or more respective identifiers corresponding to one or more respective channel management resources of a channel management resource set, and the network node determines the second beam information based on the one or more respective identifiers.

Accordingly, wireless communication devices may perform enhanced dynamic beam adjustment operations for wireless communication devices. By performing enhanced dynamic beam adjustment throughput can be increased and latency and errors can be reduced.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-14 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on A” (where “A” may be information, a condition, a factor, or the like) shall be construed as “based at least on A” unless specifically recited differently.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network node for wireless communication, comprising:
at least one processor; and
a memory coupled to the at least one processor,
wherein the at least one processor is configured to:
obtain first beam information, wherein the first beam information comprises at least one of: first beam shape information or first inter-beam pointing direction neighboring information;
receive a transmission including an indication indicative of a change to beam information;
switch from the first beam information to second beam information based on the indication; and
perform one or more operations based on the second beam information.

2. The network node of claim 1, wherein to obtain the first beam information, the at least one processor is configured to:
receive a radio resource control (RRC) configuration indicating the first beam information;
receive downlink control information (DCI) and determine, based on the DCI, the first beam information; or
receive a medium access control (MAC) control element (CE) (MAC-CE) and determine, based on the MAC-CE, the first beam information.

3. The network node of claim 1, wherein to perform the one or more operations, the at least one processor is configured to:
perform artificial intelligence- or machine learning-assisted beam selection using the second beam information;
perform one or more measurements using the second beam information;
transmit a transmission using the second beam information;
receive a transmission using the second beam information; or
report the second beam information.

4. The network node of claim 1, wherein the second beam information comprises at least one of: second beam shape information or second inter-beam pointing direction neighboring information.

5. The network node of claim 4, wherein the second beam shape information comprises at least one of: second beam direction information, second beam weight information, or second beam width information.

6. The network node of claim 4, wherein the second inter-beam pointing direction neighboring information comprises spatial information.

7. The network node of claim 6, wherein the spatial information indicates one or more adjacent beams for a particular beam.

8. The network node of claim 1, wherein the first beam shape information comprises at least one of: second beam direction information, second beam weight information, or second beam width information.

9. The network node of claim 1, wherein the first inter-beam pointing direction neighboring information comprises spatial information.

10. The network node of claim 9, wherein the spatial information indicates one or more adjacent beams for a particular beam.

11. The network node of claim 1, wherein the transmission comprises downlink control information (DCI) or a medium access control (MAC) control element (CE) (MAC-CE).

12. The network node of claim 1, wherein the transmission comprises downlink control information (DCI), wherein the DCI includes a triggering command for an aperiodic channel state information (CSI) report and aperiodic CSI triggering state information, and wherein the at least one processor is configured to:
determine the second beam information based on the aperiodic CSI triggering state information of the DCI.

13. The network node of claim 12, wherein the CSI report is an aperiodic CSI report, and wherein the aperiodic CSI triggering state information is included in a CSI request field of the DCI and the DCI includes a plurality of CSI report information elements associated with the aperiodic CSI triggering state information, and wherein at least one CSI report information element of the plurality of CSI report information elements comprises at least one channel management resource set identifier and beam information associated with the channel management resource set.

14. The network node of claim 12, wherein the at least one processor is configured to:
determine that the second beam information corresponds to a single instance of a configured periodic or semi-periodic channel management resource set; and
switch from the second beam information to the first beam information, after the performance of the one or more operations for the single instance, for subsequent instances of the configured periodic or semi-periodic channel management resource set.

15. The network node of claim 12, wherein the at least one processor is configured to:
determine that the second beam information corresponds to each respective instance of a plurality of instances of a configured periodic or semi-periodic channel management resource set; and
transmit channel state information (CSI) report information for the plurality of instances of the configured periodic or semi-periodic channel management resource set using the second beam information.

16. The network node of claim 12, wherein the at least one processor is configured to.
receive an RRC message including an information element for a channel management resource set associated with the aperiodic CSI triggering state information, wherein the information element does not indicate beam information for dynamic adjustment or the first beam information, and wherein to obtain the first beam information, the at least one processor is configured to:
receive, prior to the receipt of the transmission, a second transmission which includes the first beam information, and wherein the transmission includes the second beam information.

17. The network node of claim 12, wherein to obtain the first beam information, the at least one processor is configured to:
receive an RRC message including an information element for a channel management resource set associated with the aperiodic CSI triggering state information, wherein the information element includes the first beam information, and wherein the transmission includes the second beam information.

18. The network node of claim 12, wherein to obtain the first beam information, the at least one processor is configured to:
receive an RRC message including an information element for a channel management resource set associated with the aperiodic CSI triggering state information, wherein the information element includes the first beam information and the second beam information, and wherein the transmission includes a channel management resource set identifier configured to identify the second beam information of the information element.

19. The network node of claim 1, wherein the transmission comprises downlink control information (DCI), wherein the DCI includes an activation command for a semi-persistent channel state information (CSI) report and semi-persistent CSI triggering state information, and wherein the at least one processor is configured to:
determine the second beam information based on the semi-persistent CSI triggering state information.

20. The network node of claim 19, wherein the CSI report is a semi-persistent CSI report, and wherein the semi-persistent CSI triggering state information is included in a CSI request field of the DCI and the DCI includes a CSI report information element associated with the semi-persistent CSI triggering state information, and wherein the CSI report information element comprises at least one channel management resource set identifier and beam information associated with the channel management resource set.

21. The network node of claim 19, wherein the at least one processor is configured to:
determine that the second beam information corresponds to multiple instances of a configured periodic or semi-periodic channel management resource set;
use the second beam information for the multiple instances of the configured periodic or semi-periodic channel management resource set;
receive a deactivation message for the second beam information during the configured periodic or semi-periodic channel management resource set;
switch from the second beam information to the first beam information based on the deactivation message; and
use the first beam information for remaining instances of the configured periodic or semi-periodic channel management resource set.

22. The network node of claim 19, wherein the at least one processor is configured to:
determine that the second beam information corresponds to each respective instance of a plurality of instances of a configured periodic or semi-periodic channel management resource set; and
transmit channel state information (CSI) report information for the plurality instances of the configured periodic or semi-periodic channel management resource set using the second beam information.

23. The network node of claim 1, wherein the transmission comprises a medium access control (MAC) control element (CE) (MAC-CE), wherein the MAC-CE includes an activation command for a semi-persistent (SP) channel state information (CSI) (SP-CSI) report, wherein the MAC-CE includes an indication corresponding to the second beam information, and wherein the at least one processor is configured to:
obtain, based on the indication corresponding to the second beam information, the second beam information from the memory, wherein the second beam information is associated with a configured channel management resource set, and wherein the configured channel management resource set is associated with the SP-CSI report activated by the transmission.

24. The network node of claim 23, wherein the MAC-CE comprises a SP-CSI report activation MAC-CE or a SP-CSI resource set activation MAC-CE, and wherein the indication corresponding to the second beam information comprises at least one of:
one or more bits corresponding to a first SP-CSI report activation MAC-CE format;
one or more bits corresponding to a first SP-CSI resource set activation MAC-CE format;
one or more bits corresponding to a second SP-CSI report activation MAC-CE format for dynamic alteration of beam information; or
one or more bits corresponding to a second SP-CSI resource set activation MAC-CE format for dynamic alteration of beam information.

25. The network node of claim 23, wherein the configured channel management resource set comprises a configured periodic or semi-periodic channel management resource set, and wherein the at least one processor is configured to:
determine that the second beam information corresponds to multiple CSI reports of a configured periodic or semi-periodic channel management resource set;
use the second beam information for at least one CSI report of the multiple CSI reports of the configured periodic or semi-periodic channel management resource set;
receive a deactivation message for the second beam information during the configured periodic or semi-periodic channel management resource set;
switch from the second beam information to the first beam information based on the deactivation message; and
use the first beam information for remaining CSI reports of the multiple CSI reports.

26. The network node of claim 23, wherein the configured channel management resource set comprises a configured periodic or semi-periodic channel management resource set, wherein the at least one processor is configured to:
determine that the second beam information corresponds to each respective instance of a plurality of instances of a configured periodic or semi-periodic channel management resource set; and
transmit CSI report information for the plurality instances of the configured periodic or semi-periodic channel management resource set using the second beam information.

27. The network node of claim 1, wherein the transmission includes an indication of the second beam information, wherein the indication includes one or more respective identifiers corresponding to one or more respective channel management resources of a channel management resource set, and wherein the at least one processor is configured to:
determine the second beam information based on the indication of the second beam information.

28. The network node of claim 1, wherein the transmission includes an indication of the second beam information, wherein the indication includes an identifier corresponding to a channel management resource set, and wherein the at least one processor is configured to:
determine the second beam information based on the indication of the second beam information.

29. The network node of claim 1, wherein the transmission includes the second beam information, wherein the second beam information is associated with an identifier, and wherein the identifier corresponds to one or more respective identifiers corresponding to one or more respective channel management resources of a channel management resource set, and wherein the at least one processor is configured to:
determine the second beam information based on the indication of the second beam information.

30. The network node of claim 1, wherein the second beam information is differentially indicated in the transmission, and wherein the at least one processor is configured to:
identify the second beam information based on the first beam information and a difference indicated by the transmission, wherein the difference identifies a change in value from a second parameter of the second beam information as compared to a first parameter of the first beam information.

31. The network node of claim 1, wherein the transmission comprises a medium access control (MAC) control element (CE) (MAC-CE), and wherein the at least one processor is configured to:
transmit an acknowledgement message indicative of successful receipt of the MAC-CE, and wherein the second beam information is valid for:
a quantity of slots after the transmission of the acknowledgement message, wherein the quantity is less than or equal to 5; or
a time period after the transmission of the acknowledgement message, wherein the time period is less than or equal to 5 milliseconds.

32. The network node of claim 1, wherein the transmission comprises a medium access control (MAC) control element (CE) (MAC-CE), and wherein the at least one processor is configured to:
transmit an acknowledgement message indicative of successful receipt of the MAC-CE, and wherein the second beam information is valid after:
a quantity of slots after the transmission of the acknowledgement message, wherein the quantity is less than or equal to 5; or
a time period after the transmission of the acknowledgement message, wherein the time period is less than or equal to 5 milliseconds.

33. The network node of claim 1, wherein the transmission comprises downlink control information (DCI), and wherein the second beam information is valid:
after a first quantity of slots after the receipt of the DCI and until an end of the configured periodic or semi-periodic channel measurement resources, wherein the first quantity is less than or equal to 5;
after a second quantity of slots after the receipt of the DCI and until a third quantity of slots after the receipt of the DCI, wherein the second quantity is less than or equal to 3 and the third quantity is less than or equal to 5; or
after a fourth quantity of slots after the receipt of the DCI and until a last channel state information (CSI) report of a channel management resource set associated with the indication, wherein the fourth quantity is less than or equal to 5.

34. The network node of claim 1, wherein the transmission comprises DCI, and wherein the second beam information is valid:
after a first time period after the receipt of the DCI and until an end of the configured periodic or semi-periodic channel measurement resources, wherein the first time period is less than or equal to 5 milliseconds;
after a second time period after the receipt of the DCI and until a third time period after the receipt of the DCI, wherein the second time period is less than or 3 milliseconds and the third time period is less than or equal to 5 milliseconds; or
after a fourth time period after the receipt of the DCI and until a last channel state information (CSI) report of a channel management resource set associated with the indication, wherein the fourth time period is less than or equal to 5 milliseconds.

35. The network node of claim 1, wherein, to obtain the first beam information, the at least one processor is configured to:
receive a radio resource control (RRC) message including channel state information (CSI) interference measurement (IM) resources for interference measurement; and
determine the first beam information based on the CSI IM resources, and wherein the at least one processor is configured to:
determine the second beam information based on at least one of the CSI IM resources or the transmission.

36. A network node configured for wireless communication, comprising:
at least one processor; and
a memory coupled to the at least one processor,
wherein the at least one processor is configured to:
transmit first beam information;
transmit a transmission including an indication indicative of a change to beam information;
switch from the first beam information to second beam information based on the indication; and
perform one or more operations based on the second beam information.

37. The network node of claim 36, wherein to perform one or more operations based on the second beam information, the at least one processor is configured to:
perform artificial intelligence- or machine learning-assisted beam selection using the second beam information;
perform one or more measurements using the second beam information;
transmit a transmission using the second beam information;
receive a transmission using the second beam information; or
report the second beam information.

38. The network node of claim 36, wherein the transmission comprises downlink control information (DCI), wherein the DCI includes a triggering command for an aperiodic channel state information (CSI) report and aperiodic CSI triggering state information, and wherein the at least one processor is configured to:
determine the second beam information based on the aperiodic CSI triggering state information of the DCI.

39. The network node of claim 38, wherein the CSI report is an aperiodic CSI report, and wherein the aperiodic CSI triggering state information is included in a CSI request field of the DCI and the DCI includes a plurality of CSI report information elements associated with the aperiodic CSI triggering state information, and wherein at least one CSI report information element of the plurality of CSI report information elements comprises at least one channel management resource set identifier and beam information associated with the channel management resource set.

40. The network node of claim 36, wherein the transmission comprises downlink control information (DCI), wherein the DCI includes an activation command for a semi-persistent channel state information (CSI) report and semi-persistent CSI triggering state information, and wherein the at least one processor is configured to:
determine the second beam information based on the semi-persistent CSI triggering state information.

41. The network node of claim 40, wherein the CSI report is a semi-persistent CSI report, and wherein the semi-persistent CSI triggering state information is included in a CSI request field of the DCI and the DCI includes a CSI report information element associated with the semi-persistent CSI triggering state information, and wherein the CSI report information element comprises at least one channel management resource set identifier and beam information associated with the channel management resource set.

42. The network node of claim 36, wherein the transmission comprises a medium access control (MAC) control element (CE) (MAC-CE), wherein the MAC-CE includes an activation command for a semi-persistent (SP) channel state information (CSI) (SP-CSI) report, wherein the MAC-CE includes an indication corresponding to the second beam information, and wherein the at least one processor is configured to:
obtain, based on the indication corresponding to the second beam information, the second beam information from the memory, wherein the second beam information is associated with a configured channel management resource set, and wherein the configured channel management resource set is associated with the SP-CSI report activated by the transmission.

43. The network node of claim 36, wherein the indication identifies the second beam information, wherein the indication includes one or more respective identifiers corresponding to one or more respective channel management resources of a channel management resource set, and wherein the at least one processor is configured to:
determine the second beam information based on the one or more respective identifiers.
